(19) United States
(12) Patent Application Publication
(10) Pub. No.: US 2005/0041132 A1
(43) Pub. Date: Feb. 24, 2005

(54) Electronic camera

(75) Inventors: Masahiro Juen, Yokohama (JP); Tsutomu Narisawa, Kitaadachi-gun (JP)

Correspondence Address: MILES & STOCKBRIDGE PC, 1751 PINNACLE DRIVE, SUITE 500, MCLEAN, VA, 22102-3833, US

(73) Assignee: Nikon Corporation

(21) Appl. No.: 10/958,389

(22) Filed: Oct. 6, 2004

Related U.S. Application Data
(63) Continuation of application No. 09/709,520, filed on Nov. 13, 2000, now abandoned.
Application No. 09/709,520 is a continuation of application No. 08/982,379, filed on Dec. 2, 1997, now abandoned.
(60) Provisional application No. 60/049,001, filed on Jun. 9, 1997.

(30) Foreign Application Priority Data
Dec. 2, 1996 (JP) 8-321805
Feb. 21, 1997 (JP) 9-036801
Jun. 17, 1997 (JP) 09-160135

(51) Int. Cl. H04N 5/222

(52) U.S. Cl. 348/333.12

(57) ABSTRACT

An electronic camera is provided with a display device which displays moving-picture image information under a display format that provides additional information useful to the photographer. The display format may include simultaneous display of moving-picture and still-picture images in different parts of the same display screen, with the display of the still-picture image(s) conveying such information as the status of a recording operation, the status of a power supply battery, and/or images that have previously been recorded by the camera.

### CROSS-REFERENCE TO RELATED APPLICATIONS

This application claims the benefit of provisional application No. 60/049,001 filed Jun. 9, 1997.

This application also claims the priority of Japanese Patent Application Nos. 08-321805 filed Dec. 2, 1996, 09-036801 filed Feb. 21, 1997, and 09-160135 filed Jun. 17, 1997, all of which are incorporated herein by reference.

### BACKGROUND OF THE INVENTION

1. Field of the Invention

The present invention relates to an electronic camera and is more particularly concerned with an electronic camera equipped with an image display device which, in association with an image recording operation, for example, provides information useful to the photographer, such as status information regarding an image recording operation, status information regarding a power supply battery, and/or information regarding images that have previously been recorded by the camera.

2. Related Background Art

In recent years, with advances in image processing technology, practical software for image editing has been developed which performs a thumbnail display on a monitor of an image (hereafter referred to as a “thumbnail image”) corresponding to one typical frame of moving-picture image information recorded as a video file on a recording medium such as a magnetic disk, etc. Such image editing software includes software which displays thumbnail images corresponding individually to a plurality of video files, with each thumbnail image being arranged on the front surface of a corresponding right-angled parallelepiped. The depth dimensions of the right-angled parallelepipeds are caused to correspond to the recording times of the respective video files.

By using such a thumbnail display in an electronic camera equipped with a monitor, it is possible to obtain an electronic camera which, upon the completion of image recording, performs a thumbnail display in which the image recording time is caused to correspond to the depth dimension of the thumbnail image.

However, in such an electronic camera, the operator cannot confirm operations while image recording is in the process of being performed. For example, the operator cannot confirm that image recording is being performed.

Furthermore, since the thumbnail display with the image recording time caused to correspond to the depth of the thumbnail image is not performed until image recording has been completed, the operator has no sensory grasp of the image recording time while image recording is being performed.

Some electronic cameras use a liquid crystal display device having a large screen for externally displaying an image. An electronic camera is known which is able to display a plurality of photographed images on a large-screen display device. However, such a camera is not able to simultaneously display an image that is currently photographed, and an image or images that has/have been photographed.

Further, in an electronic camera having the display device with a large screen, the energy of the power supply is consumed at a high rate, and tends to be insufficient in an early period of the operation of the camera, thus causing disadvantages in photographing operations, such as missing a photo opportunity.

Numerous types of cameras having a battery check function are known. One example of such cameras is adapted to display a numerical value representing the remaining amount of electric power of its power supply when a power supply voltage of the camera becomes equal to or lower than a predetermined level. Another example is adapted to symbolically display a warning regarding a lack of energy of the power supply (by turning on a light or displaying a warning).

Such conventional cameras require a special display element (such as a segment display element or an exclusive symbol display element or light-emitting element for warning), so as to display the result of the battery check. The provision of such a display element may result in an increased cost of the product. Further, the warning display provided upon checking of the battery is not located in a position that can be easily viewed, as compared with displays indicative of other information. The warning display also has a relatively small display size, and is thus viewed with some difficulty.

### SUMMARY OF THE INVENTION

The present invention has been conceived in view of the aforementioned problems and accordingly has, as one of its objects., to provide an electronic camera which is designed so that when moving-picture image information is produced and recorded on a recording medium, the camera can reliably indicate to the operator that image recording is being performed, while at the same time performing a display in a form which allows the operator to obtain a sensory grasp of the passage of time from the time that recording is initiated.

It is another object of the invention to provide an electronic camera equipped with a display device which enables a user of the camera to easily view a plurality of photographed images that are simultaneously displayed, including a currently photographed image.

Still another object of the present invention is to provide an electronic camera having a battery check function, which makes it easy to view a warning display provided for checking the battery, without requiring a special display element for warning.

In accordance with one of its principal aspects, the present invention provides an electronic camera equipped with a display device having a moving-picture display part which displays moving-picture images of an object of imaging, and a still-image display part which displays one or more still-pictures of images that have been taken with the camera. The provision of a still-image display part in combination with the moving-picture display part allows for convenient viewing of various kinds of important information during image recording. For example, the still-image display part may display a thumbnail image having a depth which increases with recording time during a recording operation. As another example, the still-image display part may display previously recorded images in association with a new recording operation. With such a display, the photographer may compose images to be newly recorded in consideration of images that have already been taken. In one preferred mode, the still-image display is performed in such a manner as to provide an indication of battery status.

In accordance with another of its principal aspects, the present invention provides an electronic camera wherein the image display is controlled so as to provide a readily viewable indication of low or reduced battery power. Such an indication may be made, for example, by setting the active region (region used for image display) of a still-image display part or a moving-picture display part depending upon the battery status.

The invention and its many advantages will be more fully understood from the following detailed description taken in conjunction with the accompanying drawings.

### BRIEF DESCRIPTION OF THE DRAWINGS

FIG. 1 is a basic block diagram illustrating principal portions of a first apparatus of the invention.

FIG. 2 is a basic block diagram illustrating principal portions of a second apparatus of the invention.

FIG. 3 is a functional block diagram of a first preferred implementation of the apparatus of FIG. 1.

FIG. 4 is an operational flow chart of the apparatus of FIG. 3.

FIGS. 5A and 5B are diagrams illustrating examples of a monitor display.

FIGS. 6A and 6B are diagrams illustrating additional examples of the monitor display.

FIG. 7 is a functional block diagram of a second preferred implementation of the apparatus of FIG. 1.

FIG. 8 is an operational flow chart of the apparatus of FIG. 7.

FIGS. 9A and 9B are diagrams illustrating examples of the monitor display.

FIG. 10 is an operational flow chart of a third preferred implementation of the apparatus of FIG. 1.

FIGS. 11A and 11B are diagrams illustrating examples of the monitor display.

FIG. 12 is a functional block diagram of a preferred implementation of the apparatus of FIG. 2.

FIG. 13 is an operational flow chart of the apparatus of FIG. 12.

FIG. 14 is a basic block diagram of an electric system of an electronic camera according to the invention.

FIG. 15 is a rear view of an electronic camera incorporating the system of the FIG. 14.

FIG. 16 is a flow chart showing a control program of a microcomputer of the electronic camera of FIGS. 14 and 15.

FIG. 17 is a flow chart showing a control program of the microcomputer of the electronic camera of FIGS. 14 and 15.

FIGS. 18A and 18B are explanatory views showing examples of displays on a large-screen liquid crystal display device of the electronic camera of FIGS. 14 and 15.

FIG. 19 is an explanatory view showing an example of a display on the large-screen liquid crystal display device.

FIG. 20A is a rear view of an electronic camera according to another embodiment of the present invention.

FIG. 20B is a flow chart showing a control program of a microcomputer of the electronic camera of FIG. 20A.

FIG. 21 is an explanatory view showing an example of a display on a large-screen crystal display device.

FIG. 22 is a flow chart showing a control program of a microcomputer of still another electronic camera according to the present invention.

FIG. 23 is an explanatory view showing an example of a display on a large-screen liquid crystal display of the electronic camera of FIG. 22.

### DETAILED DESCRIPTION OF THE INVENTION

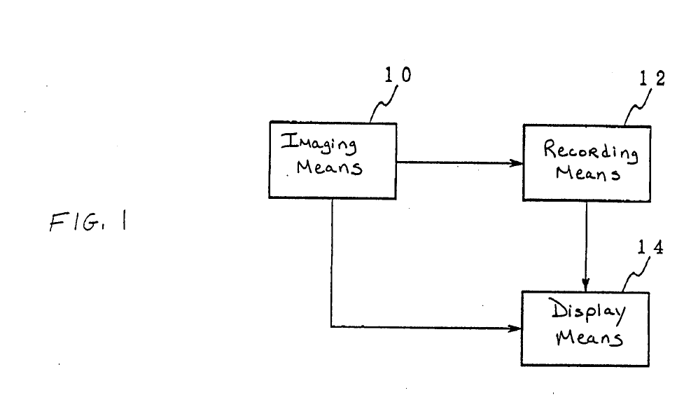

FIG. 1 is a basic block diagram which illustrates principal portions of a first apparatus of the invention.

The apparatus shown in FIG. 1 is a system of an electronic camera. The camera is characterized by the fact that it is equipped with an imaging means 10 which images an object of imaging and generates moving-picture image information, a recording means 12 which records the image information generated by the imaging means 10 on a recording medium, and a display means 14 which displays a thumbnail image corresponding to one frame of the image information when the generation or recording of the image information is initiated. The display means 14 displays the thumbnail image with a dimension of depth when it is ascertained that recording of the image information is being continued by the recording means 12, and causes the depth dimension to increase as the time during which the recording is performed passes.

When moving-picture image information is produced by the imaging means 10 and the recording of this image information is initiated by the recording means 12, image information that is to form a thumbnail image is displayed as a thumbnail image via the display means 14 with a predetermined timing. Furthermore, when the recording of image information is continued by the recording means 12, the display means 14 increases the depth dimension of the thumbnail image with a predetermined timing, or increases this depth dimension continuously as time elapses. Such a continuous or intermittent increase with elapsed time (which may include unchanging states at intermediate points) is referred to as a “monotonic non-decrease” herein.

Specifically, even while the recording of image information is being continuously performed, the depth dimension of the thumbnail image is increased in a monotonically non-decreasing manner as time elapses. Accordingly, the fact that image information is being recorded can be reliably confirmed by the operator.

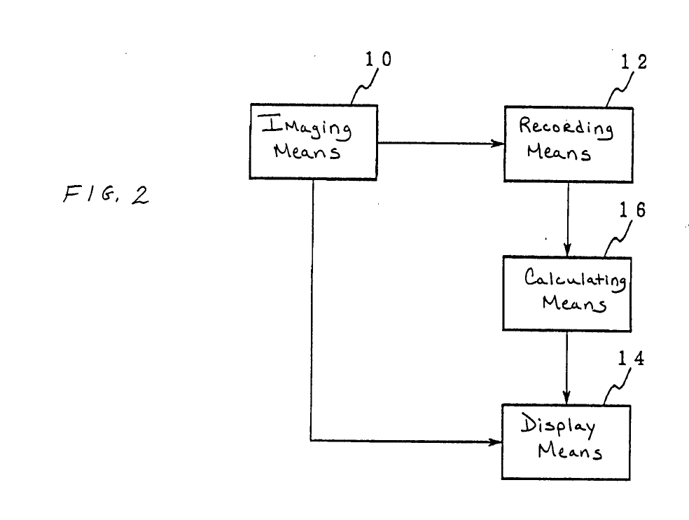

FIG. 2 is a block diagram which illustrates principle portions of a second apparatus of the invention.

The apparatus shown in FIG. 2 is characterized by the fact that in the electronic camera of FIG. 1, a calculating means 16 is provided which calculates the recording capacity of the above-mentioned image information (which changes with the passage of time in the process of recording on the recording medium by the recording means 12), and the display means 14 causes the depth dimension of the thumbnail image to increase in a monotonically non-decreasing manner in correspondence with the recording capacity calculated by the calculating means 16.

When moving-picture image information is produced by the imaging means 10 and the recording of this image information is initiated by the recording means 12, image information that is to form a thumbnail image is displayed as a thumbnail image via the display means 14 with a predetermined timing. When the recording of image information is initiated by the recording means 12, the calculating means 16 calculates the quantity of information recorded on the recording medium with a predetermined fixed or non-fixed timing. The display means 14 performs a display in which the depth dimension of the thumbnail image is caused to increase in a monotonically non-decreasing manner in correspondence with the amount of information thus calculated by the calculating means 16.

Accordingly, even while image information is being continuously recorded, the depth dimension of the thumbnail image is caused to increase in a monotonically non-decreasing manner in accordance with the change in the amount of image information. Thus, the fact that image information is being recorded can be reliably confirmed by the operator.

The apparatus of FIGS. 1 and 2 may be further characterized by the fact that the above-mentioned display means 14 displays an index corresponding to the amount of change in the depth dimension of the thumbnail image in a format which is predetermined in the direction of depth.

More particularly, the display means displays an index corresponding to the time for which the recording of image information has been continuously performed, or to the change in the amount of image information, in the direction of depth of the thumbnail image.

Accordingly, since the change in the depth dimension of the thumbnail image is clearly indicated, the time from the initiation of recording or the change in the recording capacity can be grasped in sensory terms by the operator.

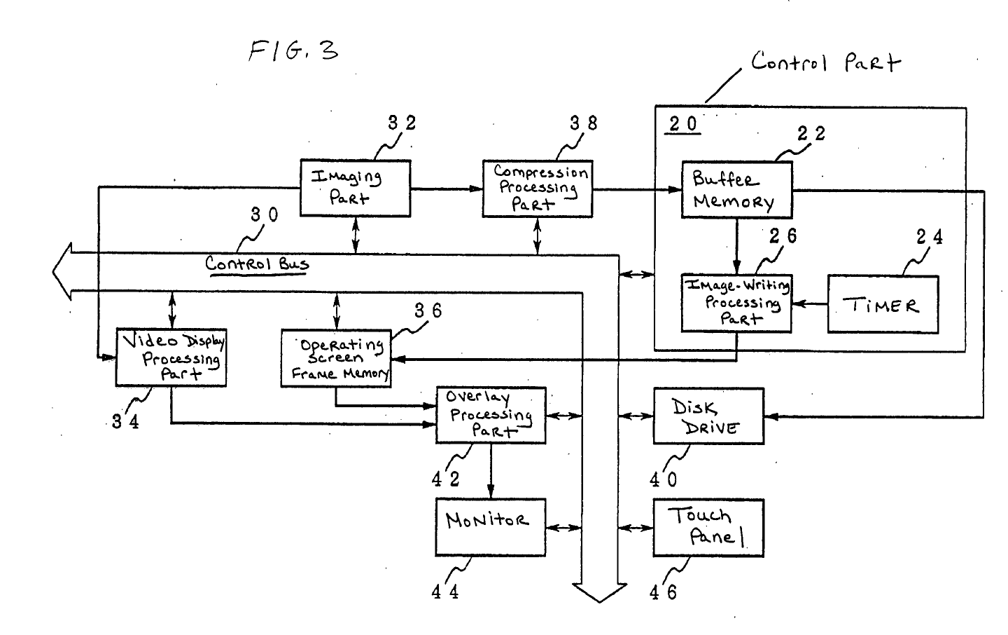

FIG. 3 is a functional block diagram of an electronic camera implementing the apparatus of FIG. 1.

As shown in FIG. 3, the camera system includes a control part 20 which has a buffer memory 22, a timer 24 and an image-writing processing part 26. The control part 20 is connected to an imaging part 32, a video display processing part 34, an operating screen frame memory 36, a compression processing part 38, a disk drive 40, an overlay processing part 42, a monitor 44 and a touch panel 46, all via a control bus 30.

In the electronic camera constructed as described above, the control part 20 performs timing control, etc., for the imaging part 32, video display processing part 34, operating screen frame memory 36, compression processing part 38, disk drive 40, overlay processing part 42, monitor 44 and touch panel 46, all via the control bus 30.

The imaging part 32 images an object of imaging and produces image information. This image information is sent to the video display processing part 34 and compression processing part 38.

The video display processing part 34 produces image information (hereafter referred to as “finder image information”) corresponding to a finder within the image displayed on the monitor 44. This information is produced by subjecting the image information sent from the imaging part 32 to pixel density conversion, and the video display processing part sends this information to the overlay processing part 42.

The compression processing part 38 subjects the image information sent from the imaging part 32 to image compression, and sends the resulting image information to the image-writing processing part 26 and disk drive 40 via the buffer memory 22. The disk drive 40 records the image information compressed by the compression processing part 38 as a video file on a recording medium such as a magnetic disk, etc.

The image-writing processing part 26 produces image information (hereafter referred to as “operating screen image information”) corresponding to predetermined operating controls, such as a record button, a stop button, etc., to be displayed within the image displayed on the monitor 44. This image information is stored in a predetermined position in the operating screen frame memory 36 on the basis of the construction of the operating screen, and is sent to the overlay processing part 42 with a timing designated by the control part 20.

Each time that a predetermined period of time elapses, the timer 24 informs the image-writing processing part 26 of this, and the image-writing processing part 26 performs image-writing processing (described later) for the image information which has been compressed by the compression processing part 38 and sent to the image-writing processing part 26 via the buffer memory 22. The image-writing processing part 26 then sends the processed image information to the overlay processing part 42.

The overlay processing part 42 superimposes the finder image information sent from the video display processing part 34 and the operating screen image information sent from the operating screen frame memory 36, and sends the image information thus produced to the monitor 44.

The monitor 44 displays the image information sent from the overlay processing part 42 as an image, and the touch panel 46 receives external operations applied to the operating screen displayed on the monitor 44.

With regard to the correspondence between the elements of FIG. 3 and the block diagram shown in FIG. 1, the imaging part 32 corresponds to the imaging means 10, the disk drive 40 corresponds to the recording means 12, and the monitor 44 and image-writing processing part 26 correspond to the display means 14.

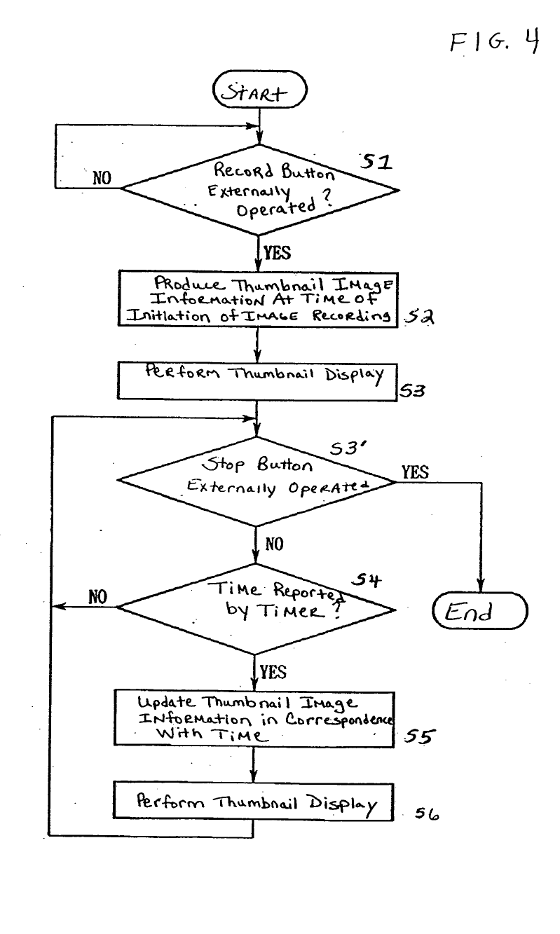

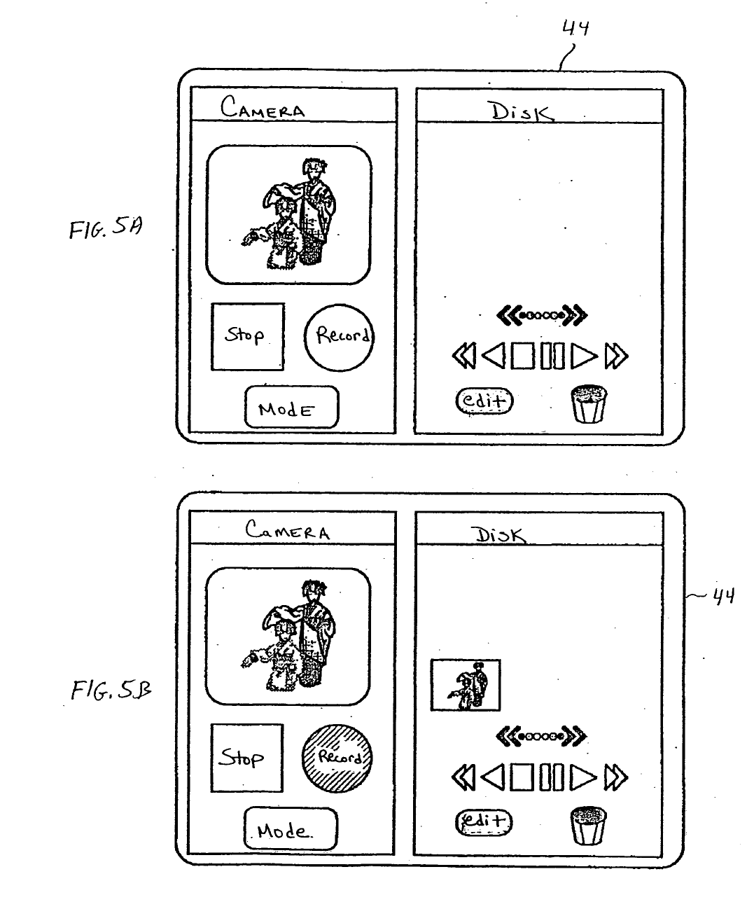

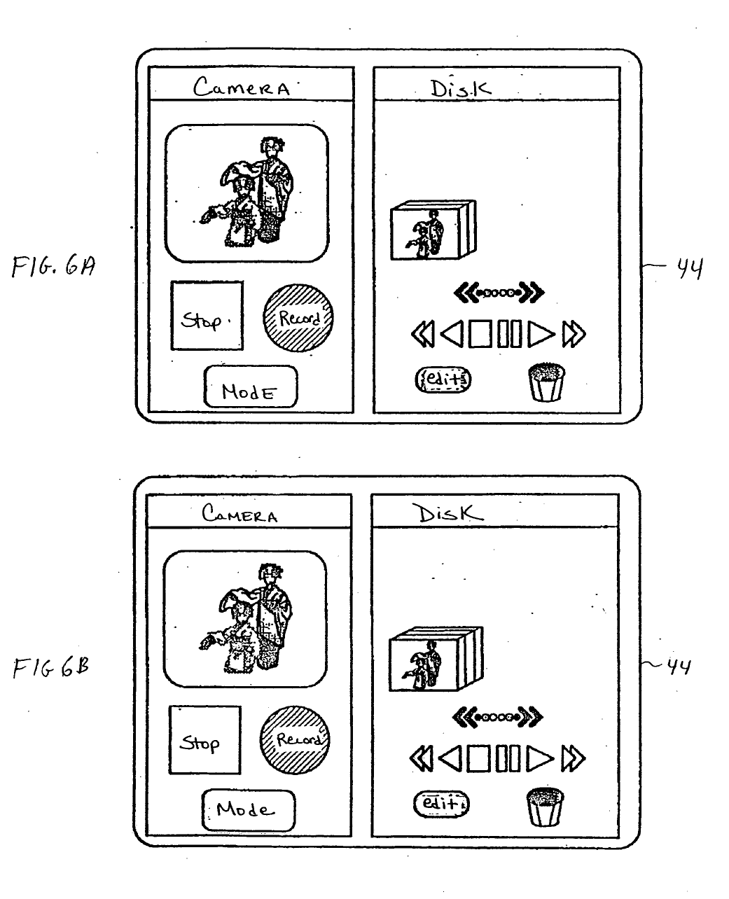

FIG. 4 is an operational flow chart of the electronic camera of FIG. 3, and FIGS. 5A-6B show examples of the display on monitor 44. In FIGS. 5A-6B, the camera window and disk window constitute the operating screen. The camera window is formed with regions (icons) corresponding to a record button, a stop button, and a finder, while the disk window is formed with regions (icons) corresponding to operating parts for disk editing, etc.

When an operating screen is displayed on the monitor 44 as shown in FIGS. 5A-6B, the control part 20 constantly monitors the touch panel 46 via the control bus 30 in order to ascertain whether or not the touch panel 46 has been subjected to an external operation. In this way, the control part 20 judges whether or not an external operation has been performed on the record button (step S1).

When it is recognized on the basis of the above-mentioned judgement that an external operation has been performed on the record button, the control part 20 monitors the timing with which the image information produced by the imaging part 32 and compressed by the compression processing part 38 (at the point in time where the “record button” is externally operated) is sent to the disk drive 40 and image-writing processing part 26 via the buffer memory 22. When the control part 20 recognizes such timing, the control part starts the disk drive 40 via the control bus 30, and also starts the timer 24 and the image-writing processing part 26.

When the image-writing processing part 26 is thus started, the image-writing processing part 26 processes the image information sent from the buffer memory 22 and performing a pixel density conversion so that image information (hereafter referred to as “thumbnail image information”) corresponding to a thumbnail image is produced (Step S2). The thumbnail image information thus produced is stored in the main memory (not shown in the drawings) of the control part 20, and is also stored in the operating screen frame memory 36 as a portion of the operating screen image information.

When the control part 20 recognizes that the above-mentioned thumbnail image information has been stored in the operating screen frame memory 36 as a portion of the operating screen image information, the control part 20 instructs the video display processing part 34 and operating screen frame memory 36 to send the finder image information and operating screen image information to the overlay processing part 42.

In the overlay processing part 42, the finder image information and operating screen image information are superimposed, and the resulting image information is displayed in a thumbnail display by the monitor 44 as shown in FIG. 5B (step S3).

The control part 20 judges whether or not an external operation has been performed on the stop button (step S3′). If no, the process continues.

Coordinates which are used as a reference for determining the depth dimension of the thumbnail image in correspondence with the time reported by the timer 24 are stored beforehand as a table in the main memory. When the time is reported by the timer 24 at predetermined intervals (step S4), the image-writing processing part 26 reads out the coordinates corresponding to this time from the table.

When the coordinates are read out, the image-writing processing part 26 produces image information corresponding to a rectangular line image obtained by moving a rectangular line image corresponding to the edges of the thumbnail image horizontally in the direction indicated by the above-mentioned coordinates, and a line image which connects the respective corresponding points of these rectangles. Then, by performing line-hiding processing on the line-image information thus produced, the image-writing processing part 26 produces image information (hereafter referred to as “depth image information”) corresponding to a perspective view of a right-angled parallelepiped.

When the image-writing processing part 26 thus produces the depth image information, the thumbnail image information is read out from the main memory, and the thumbnail image information is updated by superimposing these two sets of image information (step S5).

The thumbnail image information which has thus been updated is again stored in the main memory, and is also stored in the operating screen frame memory 36 as a portion of the operating screen image information. The operating screen image information stored in the operating screen frame memory 36 is superimposed on the finder image information by the overlay processing part 42, and the resulting (superimposed) image information is displayed as a thumbnail display on the monitor 44 as shown in FIG. 6A (step S6).

In the image-writing processing part 26, updating of the thumbnail image information is performed until it is recognized by the control part 20 that an external operation has been performed on the stop button. During this interval, a thumbnail display in which the depth dimension is increased as shown in FIG. 6B, for example, is provided on the monitor 44. Specifically, while image recording is being performed, a right-angled parallelepiped is added in the direction of depth of the thumbnail image at predetermined time intervals.

Accordingly, since the elapsed recording time is associated with the number of right-angled parallelepipeds, the recording time can be grasped in sensory terms by the operator, and operation can be reliably confirmed.

Furthermore, since the image information produced by the imaging part 32 at the point in time at which image recording was initiated is constantly displayed on the front surface of the perspective view of the above-mentioned right-angled parallelepiped as a thumbnail image, the operator can easily grasp the association between the depth dimension of the right-angled parallelepiped and the time elapsed from the initiation of image recording.

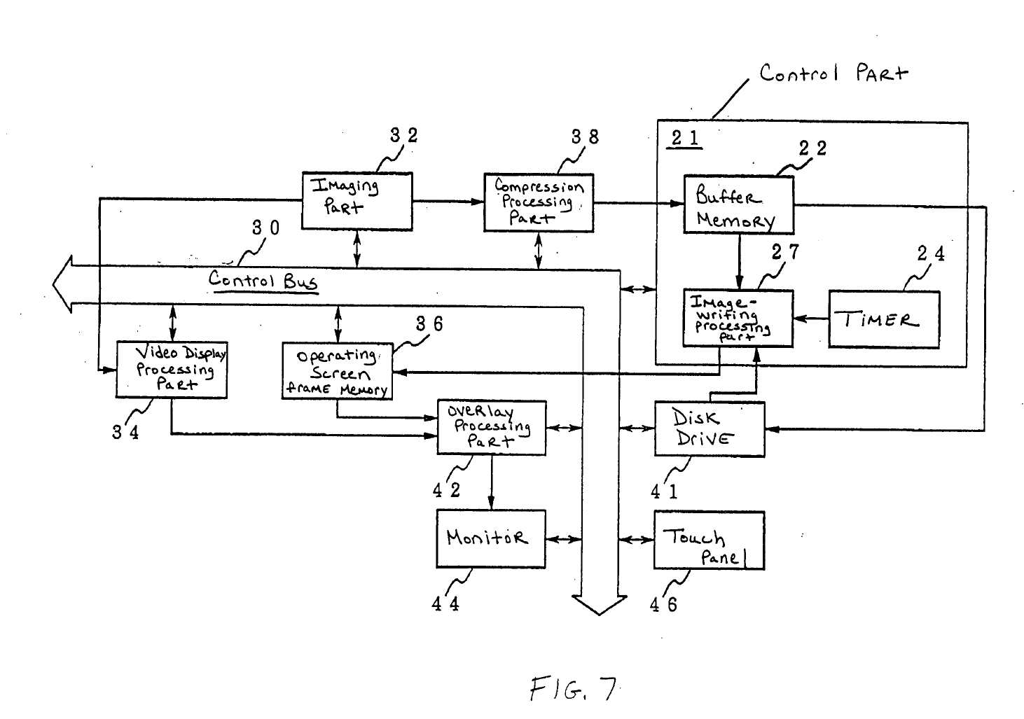

FIG. 7 is a functional block diagram of an electronic camera illustrating a second implementation of the apparatus of FIG. 1. In FIG. 7, parts which have the same functions as in the diagram shown in FIG. 3 are labeled with the same symbols, and a description of these parts is omitted here.

The main point of difference between the construction of the present implementation and that of FIG. 3 is that a control part 21, image-writing processing part 27 and disk drive 41 are installed instead of the control part 20, image-writing processing part 26 and disk drive 40 shown in FIG. 3. With regard to the correspondence between the elements of FIG. 7 and the block diagram shown in FIG. 1, the imaging part 32 corresponds to the imaging means 10, the disk drive 41 corresponds to the recording means 12, and the monitor 44 and image-writing processing part 27 correspond to the display means 14.

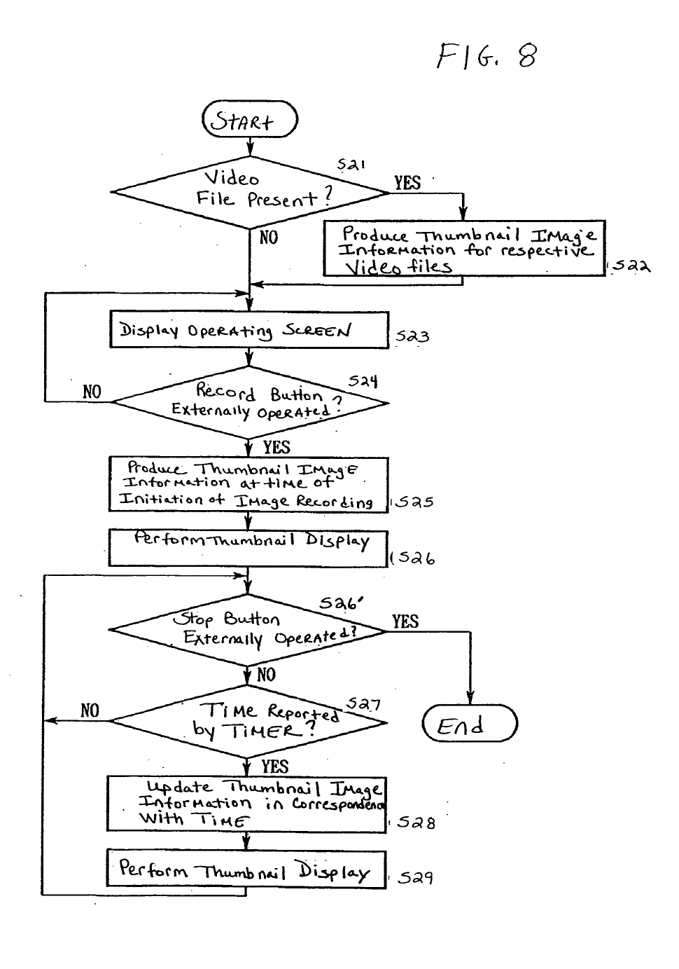

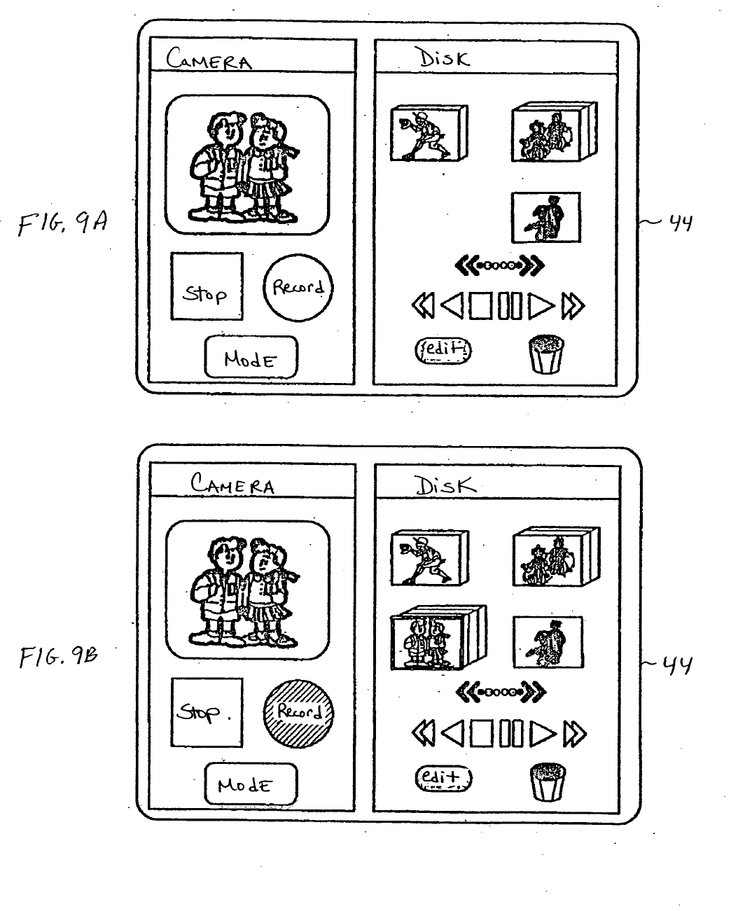

FIG. 8 is an operational flow chart of the electronic camera of FIG. 7, and FIGS. 9A and 9B show examples of the display on monitor 44. In FIGS. 9A and 9B, the camera window and disk window constitute the operating screen. The camera window is formed with regions (icons) corresponding to a record button, a stop button, and a finder, while the disk window is formed with regions (icons) corresponding to operating parts for disk editing, etc.

When the main power supply is switched on so that power from the power supply is supplied to the monitor 44 and touch panel 46, the control part 21 ascertains via the disk drive 41 whether or not any video files are present on the magnetic recording medium (magnetic disk, etc.) (step S21).

When the control part 21 recognizes as a result of the above-mentioned judgement that video files are present, the control part 21 instructs the image-writing processing part 27 and disk drive 41 to produce a thumbnail image corresponding to each video file (step S22).

In the present example, it is assumed that not only moving-picture video files, but also still-image video files, are recorded on the recording medium. For the sake of simplicity, an image corresponding to the leading frame of a file of moving-picture image information is assumed to be taken as the thumbnail image for that file.

When the disk drive 41 is instructed to produce thumbnail image information by the control part 21, the disk drive 41 successively opens a plurality of video files recorded on the recording medium. In cases where the video files thus opened are moving-picture video files, the disk drive 41 reads out image information corresponding to the leading frame, while in cases where the video files are still-image video files, the disk drive 41 reads out the still-image information.

The image information thus read out is sent to the image-writing processing part 27, where a pixel density conversion is performed.

In cases where a moving-picture video file is opened, the disk drive 41 also reads out the recording time, which is recorded in the video file as information appended to the moving-picture image information, and reports this recording time to the image-writing processing part 27.

As in the camera of FIG. 3, coordinates which are used as a reference for determining the depth dimension of the thumbnail image in correspondence with the time reported by the timer 24 are stored as a table (hereafter referred to as the “first table”) in the main memory (not shown). In addition, coordinates which are used as a reference for determining the depth dimension of the thumbnail image in correspondence with the recording time reported by the disk drive 41 are stored as a table (hereafter referred to as the “second table”) in the main memory. Here, in cases where a plurality of right-angled parallelepipeds are displayed in the direction of depth of the thumbnail image, the second table contains coordinates which are used to display each right-angled parallelepiped.

When recording times are reported to the image-writing processing part 27 by the disk drive 41, the image-writing processing part 27 successively reads out coordinates corresponding to these recording times from the second table, and produces depth image information. The image-writing processing part 27 then produces thumbnail image information by superimposing this depth image information on the image information which has been subjected to a pixel density conversion. In cases where a still-image video file is opened, the image information which has been subjected to a pixel density conversion is handled as thumbnail image information.

When thumbnail image information corresponding to the respective video files is produced, the control part 21 stores this image information in the operating screen frame memory 36 as a portion of the operating screen image information.

The thumbnail image information thus stored in the operating screen frame memory 36 is sent to the overlay processing part 42. This information is superimposed on the finder image information, and the resulting information is displayed as an operating screen on the monitor 44 as shown in FIG. 9A (step S23).

In the case of thumbnail images corresponding to moving-picture video files, right-angled parallelepipeds are added to the thumbnail images in the direction of depth according to the recording time. By contrast, the case of thumbnail images corresponding to still-image video files, no right-angled parallelepipeds are added to the thumbnail images.

Also, while the operating screen is being displayed, the finder image information is repeatedly updated each time that image information is produced by the imaging part 32.

When an operating screen containing a finder and a thumbnail image of an existing video file is thus displayed, the control part 21 judges whether or not an external operation has been performed on the record button (step S24).

As in the previous example of FIG. 3, when the control part 21 recognizes on the basis of such a judgement that an external operation has been performed on the record button, the control part 21 monitors the timing with which the image information produced by the imaging part 32 and compressed by the compression processing part 38 (at the point in time where the “record button” is externally operated) is sent to the disk drive 41 and image-writing processing part 27 via the buffer memory 22. When the control part 21 recognizes such timing, the control part starts the timer 24 via the control bus 30.

Also as in the previous example, when image information is sent from the buffer memory 22, the image-writing processing part 27 performs a pixel density conversion and produces thumbnail image information (step S25). At the same time, the image-writing processing part superimposes the image information corresponding to the edges of the double lines. The thumbnail image information thus produced is stored in the main memory of the control part 21, and is also stored in the operating screen frame memory 36 as a portion of the operating screen image information.

As in the previous example, when the control part 21 recognizes that the above-mentioned thumbnail image information has been stored in the operating screen frame memory 36 as a portion of the operating screen image information, the control part 21 instructs the video display processing part 34 and operating screen frame memory 36 to send the finder image information and operating screen image information to the overlay processing part 42.

In the overlay processing part 42, as in the system of FIG. 3, the finder image information and operating screen image information are superimposed, and the resulting image information is displayed in a thumbnail display by the monitor 44 (step S26).

The control part 21 judges whether or not an external operation has been performed on the stop button (step S26′). If no, the process continues.

Furthermore, as in the previous example, when the time is reported by the timer 24 at predetermined intervals (step S27), the image-writing processing part 27 reads out the coordinates corresponding to this time from the above-mentioned first table, and produces depth image information. The image-writing processing part 27 also reads out thumbnail image information form the main memory, and updates this thumbnail image information by superimposing the depth image information thereon (step S28).

The thumbnail image information which has thus been updated is again stored in the main memory, and is also stored in the operating screen frame memory 36 as a portion of the operating screen image information. The operating screen image information stored in the operating screen frame memory 36 is superimposed on the finder image information by the overlay processing part 42, and the resulting (superimposed) image information is displayed as a thumbnail display on the monitor 44 (step S29).

Specifically, while image recording is being performed, a right-angled parallelepiped is added at predetermined time intervals in the direction of depth of the thumbnail image corresponding to the video file being recorded, and at the same time a thumbnail display corresponding to the respective existing video files is performed as shown in FIG. 9B.

Accordingly, the operator can obtain a direct sensory grasp of the time elapsed from the initiation of recording by making a comparison with the recording times of existing video files.

Furthermore, since the edges of the thumbnail image corresponding to the video file being recorded are displayed as double lines, the operator can quickly discriminate the thumbnail image corresponding to the video file being recorded, even in cases where a plurality of thumbnail images corresponding to existing video files are displayed.

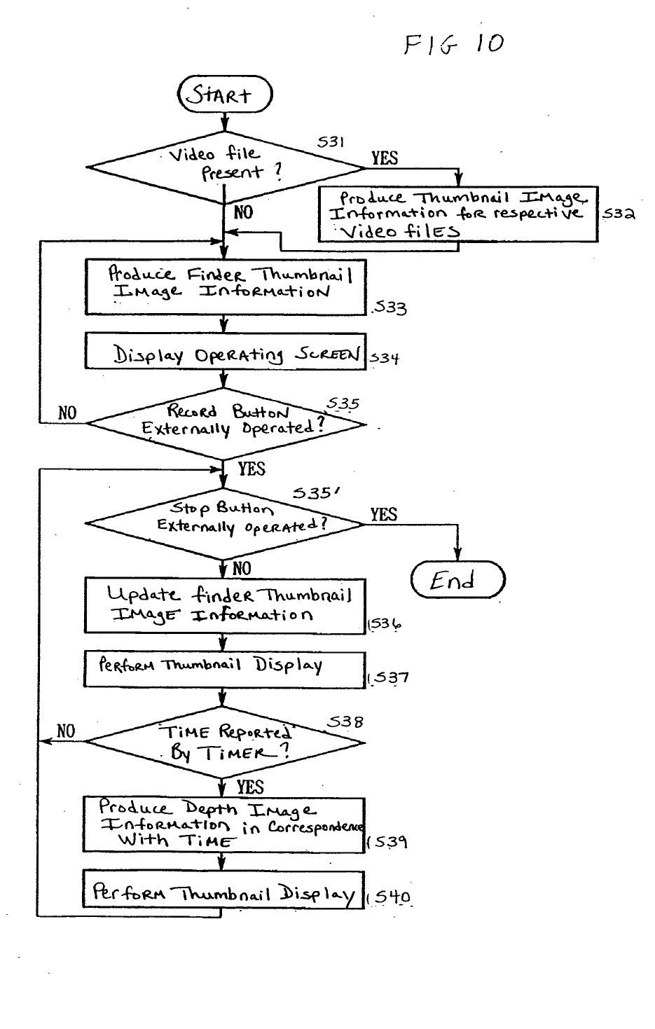

FIG. 10 is an operational flow chart of a third implementation of the apparatus shown in FIG. 1.

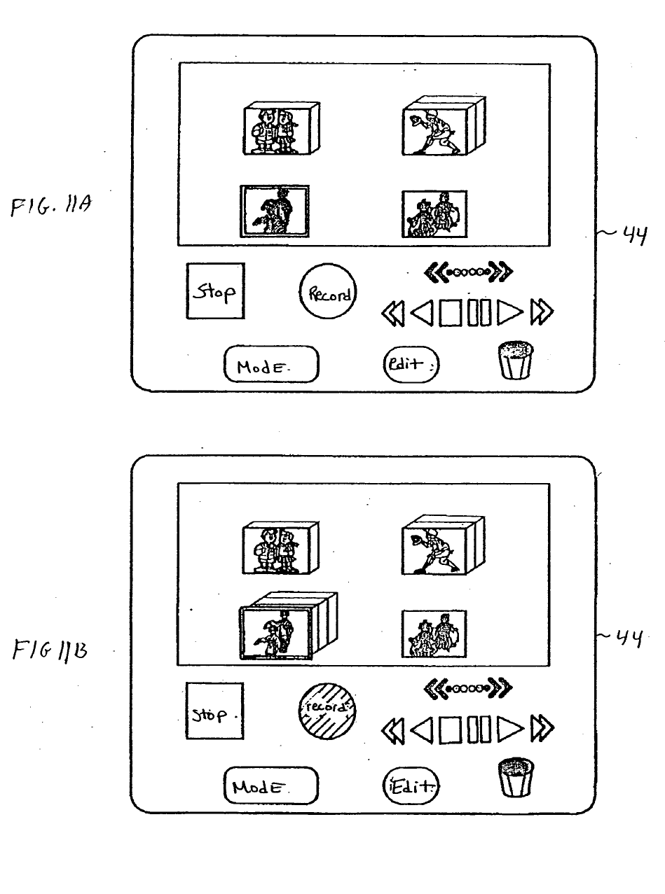

FIGS. 11A and 11B show corresponding to examples of the displays on monitor 44. In these displays, regions (icons) corresponding to a record button and a stop button and regions (icons) corresponding to operating parts for disk editing are displayed as parts of an operating screen together with thumbnail displays of existing video files.

The present implementation is characterized by the processing procedure of the control part 21, and the hardware construction is the same as that in the functional block diagram of FIG. 7.

Below, the operation of the present example will be described with reference to FIGS. 7, 10 and 11A-11B.

As in the second implementation described above, when the main power supply is switched on so that power from the power supply is supplied to the monitor 44 and touch panel 46, the control part 21 ascertains via the disk drive 41 whether or not any video files are present on the recording medium (step S31).

When the control part 21 recognizes as a result of the above-mentioned judgement that video files are present, the control part 21 instructs the image-writing processing part 27 and disk drive 41 to produce a thumbnail image corresponding to each video file (step S32).

As in the above-described second implementation, when the disk drive 41 is instructed to produce thumbnail image information by the control part 21, the disk drive 41 reads out the recording time and image information corresponding to the leading frame from moving-picture video files, and reads out still-image information from still-image video files. The image-writing processing part 27 produces thumbnail image information by subjecting the image information sent from the disk drive 41 to pixel density conversion, and superimposing depth image information in the case of moving-picture video files as previously described.

When thumbnail image information corresponding to the respective video files is thus produced, the control part 21 stores this image information in the operating screen frame memory 36 as a portion of the operating screen image information.

Each time that image information is sent to the video display processing part 34 from the imaging part 32 while operating screen image information is being produced, the video display processing part 34 performs a pixel density conversion on this image information, thus producing finder image information (hereafter referred to as “finder thumbnail image information”) of the same size as the thumbnail image information (step S33). Furthermore, the video display processing part 34 superimposes image information corresponding to the edges of the double lines on the finder thumbnail image information.

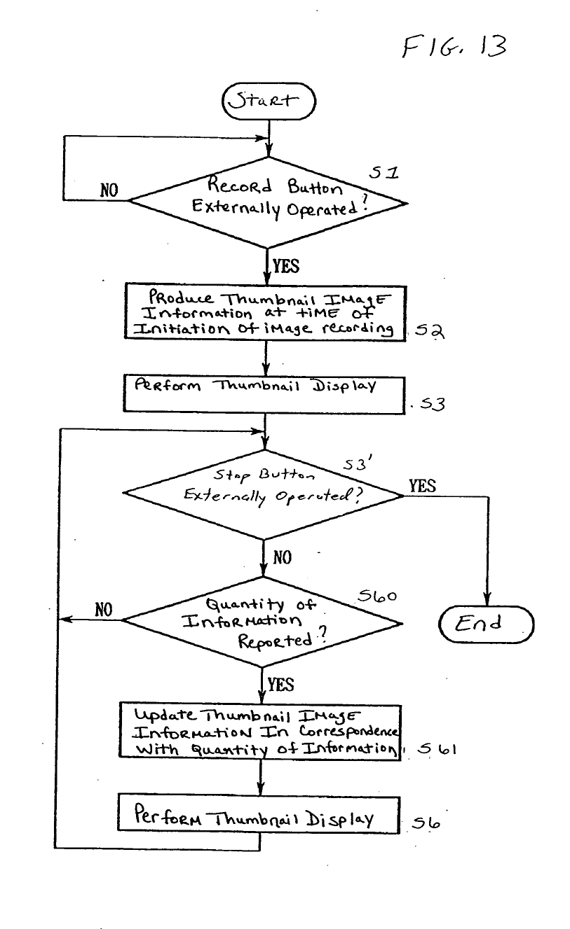

In the overlay processing part 42, the operating screen image information stored in the operating screen frame memory 36 and the finder thumbnail image information produced by the video display processing part 34 are superimposed, and the resulting image information is displayed as an operating screen by the monitor 44 as shown in FIG. 13A (step S34).

As in the above-mentioned second implementation, when an operating screen which thus contains thumbnail displays of existing video files is displayed, the control part 21 judges whether or not an external operation has been performed on the record button (step S35).

The control part 21 judges whether or not an external operation has been performed on the stop button (step S35′). If no, the process continues.

When the control part 21 recognizes as a result of such a judgement that an external operation has been performed on the record button, the control part 21 starts the timer 24 via the control bus 30.

Each time that image information is sent to the video display processing part 34 from the imaging part 32, the video display processing part 34 performs a pixel density conversion on this image information, thus updating the finder thumbnail image information (step S36). Superimposing of the image information corresponding to the edges of the double lines is also performed.

The finder thumbnail image information which has thus been updated by the video display processing part 34 is superimposed on the operating screen image information by the overlay processing part 42, and the resulting information is displayed in a thumbnail display on the monitor 44 (step S37).

When the time is reported to the image-writing processing part 27 by the timer 24 at predetermined intervals (step S38), the image-writing processing part 27 reads out the coordinates corresponding to this time from the above-mentioned first table, and produces depth image information as in the above-described second implementation (step S39).

The depth image information thus produced is stored in the main memory of the control part 21, and is also stored in the operating screen frame memory 36 as a portion of the operating screen image information.

The operating screen image information stored in the operating screen frame memory 36 is superimposed on the finder thumbnail image information by the overlay processing part 42, and the resulting image information is displayed as a thumbnail display on the monitor 44 (step S40).

The updating of the finder thumbnail image information and depth image information thus performed is repeated until it is recognized by the control part 21 that an external operation has been performed on the stop button.

Thus, while image recording is being performed, a right-angled parallelepiped is added at predetermined time intervals in the direction of depth of the finder thumbnail image, and at the same time a thumbnail display corresponding to the respective existing video files is performed, as shown in FIG. 11B.

Accordingly, the operator can obtain a direct sensory grasp of the time elapsed from the initiation of recording by making a comparison with the recording times of the existing video files. Further, since a finder image is displayed as a thumbnail image corresponding to the video file being recorded, the operator can simultaneously monitor the conditions of the object of imaging along with the elapsed recording time.

In the exemplary implementation described above, the coordinates used as a reference for determining the depth dimension of the thumbnail image were stored as a table in the main memory. However, it would also be possible to use the image-writing processing part 26 to determine such coordinates, e.g., by substituting the time reported by the timer 24 into a predetermined calculation formula, etc.

It should be noted that the timing with which the time is reported by the timer 24 can be any timing, so long as this timing is synchronized with the timing at which the depth dimension is to be increased in cases where a display is performed in which the depth dimension is increased. For example, equal intervals of roughly 1/30 to 1/40 sec, etc., may be used.

In the second and third implementations, thumbnail displays for existing video files are performed by producing thumbnail image information when the operating screen is displayed. However, it would also be possible to perform thumbnail displays for some video files by reading out thumbnail image information (including depth image information) recorded beforehand.

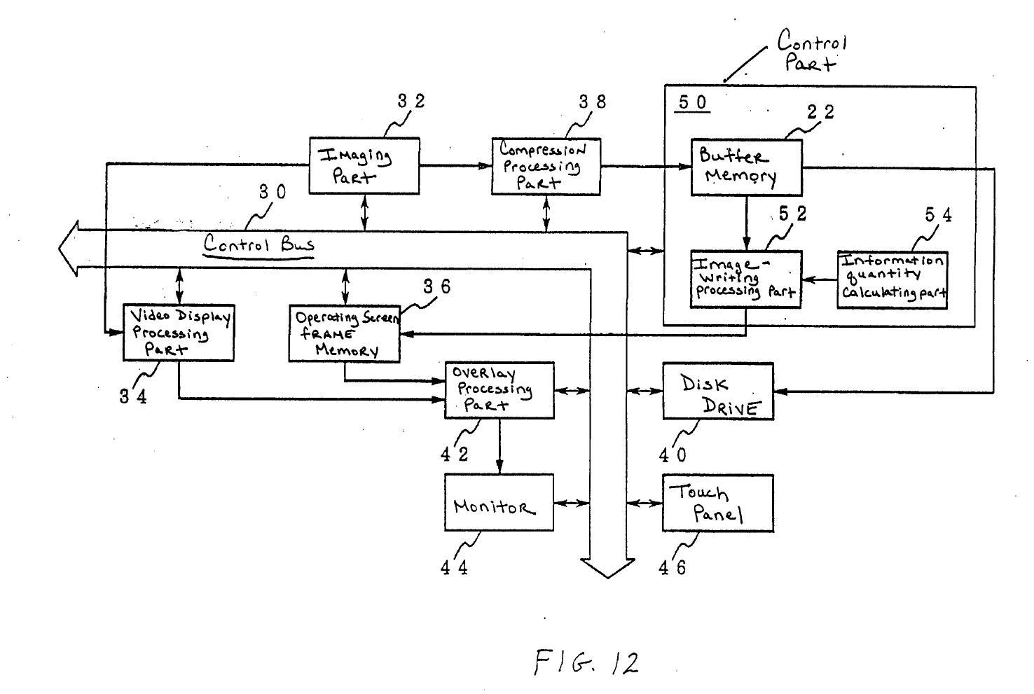

FIG. 12 is a functional block diagram of an electronic camera implementing the apparatus of FIG. 2. In FIG. 12, parts which are the same as in the block diagram of FIG. 3 are labeled with the same symbols, and a description of these parts is omitted here.

The main points of difference between the system of FIG. 12 and that of FIG. 3 are as follows: in the system of FIG. 12, a control part 50 is installed instead of the control part 20 shown in FIG. 3, and an image-writing processing part 52 and information quantity calculating part 54 are installed in the control part 50 instead of the image-writing processing part 26 and timer 24 shown in FIG. 3.

Regarding the correspondence between the elements of FIG. 12 and the block diagram shown in FIG. 2, the imaging part 32 corresponds to the imaging means 10, the disk drive 40 corresponds to the recording means 12, the monitor 44 and image-writing processing part 52 correspond to the display means 14, and the information quantity calculating part 54 corresponds to the calculating means 16.

FIG. 13 is an operational flow chart of the electronic camera of FIG. 12. In FIG. 13, processes which are the same as processes shown in FIG. 4 are labeled with the same numbers, and a description of these processes is omitted here.

As in the operational scheme of FIG. 4, the image-writing processing part 52 produces thumbnail image information (step S2), and this thumbnail image information is stored in the main memory (not shown in the drawings) of the control part 50.

The information quantity calculating part 54 is started when the control part 50 recognizes that an external operation has been performed on the record button. This information quantity calculating part 54 constantly calculates the quantity of image information recorded by the disk drive 40, and whenever the quantity of information thus calculated coincides with one of a plurality of predetermined values, the information quantity calculating part 54 reports this to the image-writing processing part 52.

Coordinates which serve as a reference for determining the depth dimension of the thumbnail image in correspondence with the quantity of information reported by the information quantity calculating part 54 are stored beforehand as a table in the main memory of the control part 50.

When a predetermined quantity of information is reported by the information quantity calculating part 54 (step S60), the image-writing processing part 52 reads out coordinates corresponding to this amount of information from the above-mentioned table.

When the corresponding coordinates are thus read out, the image-writing processing part 52 produces depth image information in the same manner as previously described in connection with FIGS. 3 and 4. The image-writing processing part 52 then reads out thumbnail image information from the main memory, and updates the thumbnail image information by superimposing the two sets of the image information (step S61).

Thus, while image recording is being performed, a display is performed in which a right-angled parallelepiped is added in the direction of depth of the thumbnail image each time that the quantity of information recorded on the recording medium coincides with a predetermined value as image recording proceeds.

Accordingly, since the quantity of information is associated with the number of right-angled parallelepipeds, changes in the quantity of information can be grasped by the operator in sensory terms, and the operation of the device can be reliably confirmed.

In the present implementation, the coordinates used as a reference for determining the depth dimension of the thumbnail image are stored as a table in the main memory. However, it would also be possible to use the image-writing processing part 52 to determine such coordinates, e.g., by substituting the quantity of information reported by the information quantity calculating part 54 into a predetermined calculation formula, etc.

It should be also noted that the quantity of information calculated by the information quantity calculating part 54 may be calculated in any desired units, such as the number of frames of image information or the number of sectors used when image information is recorded on a magnetic disk, etc.

Also, a thumbnail display of video files during image recording was described in connection with the system of FIG. 12. However, in cases where existing video files are present, it would also be possible to produce depth image information corresponding to the recording time and quantity of information of the respective existing video files, and to perform a thumbnail display of these existing video files as shown in FIGS. 9A and 9B.

In the exemplary implementation described above, the starting and stopping of image recording are accomplished by instructions given to the camera by performing external operations (via a touch panel 46) on an operating screen displayed as a camera window. However, the present invention is not limited to such an electronic camera, and may also be used in electronic cameras equipped with a record button and stop button as hardware.

Further, in the exemplary implementations described above, depth image information is produced by the image-writing processing part 26, 27 or 52 each time that the thumbnail image information is updated. However, the method used to obtain such depth image information may be any desired method. For example, all of the depth image information that is used each time that the thumbnail image information is updated may be recorded in predetermined positions in the main memory, and portions of this depth image information may be appropriately read out at the time of updating, etc.

Further still, in the exemplary implementations described above, the depth of the thumbnail image is indicated by displaying a perspective view of a right-angled parallelepiped with a thumbnail image positioned on the front surface. However, as long as a dimension of depth is indicated so that a three-dimensional display can be reliably obtained, any desired type of display, e.g., a display in which a plurality of rectangular figures are caused to overlap, etc., may be performed.

The shape of the region in which the thumbnail image is displayed need not be rectangular. So long as a display with a dimension of depth can be reliably obtained, the shape may be any desired shape.

The image information produced by the imaging part 32 at the time that image recording is initiated, or finder image information, is displayed on the front surface of the above-mentioned right-angled parallelepiped as a thumbnail image in the exemplary implementations described above. However, so long as the image displayed as a thumbnail image corresponds to one frame of image information produced in the image recording process, any desired image may be used. For example, image information produced by the imaging part 32 may be displayed as a thumbnail image each time the depth dimension of the above-mentioned right-angled parallelepiped is updated, etc.

Also in the exemplary implementations described above, an index indicating the change in the depth dimension of the thumbnail image is displayed by displaying added right-angled parallelepipeds. However, such an index may be indicated by any desired type of display. For example, the color tone of the side surface of the above-mentioned right-angled parallelepiped showing the thumbnail image on its front surface may be varied in stages, etc.

Further, instead of transferring image information between individual functional blocks as described above, it would also be possible to install a bus which doubles as a data bus instead of the above-mentioned control bus 30, and to transfer image information via this bus.

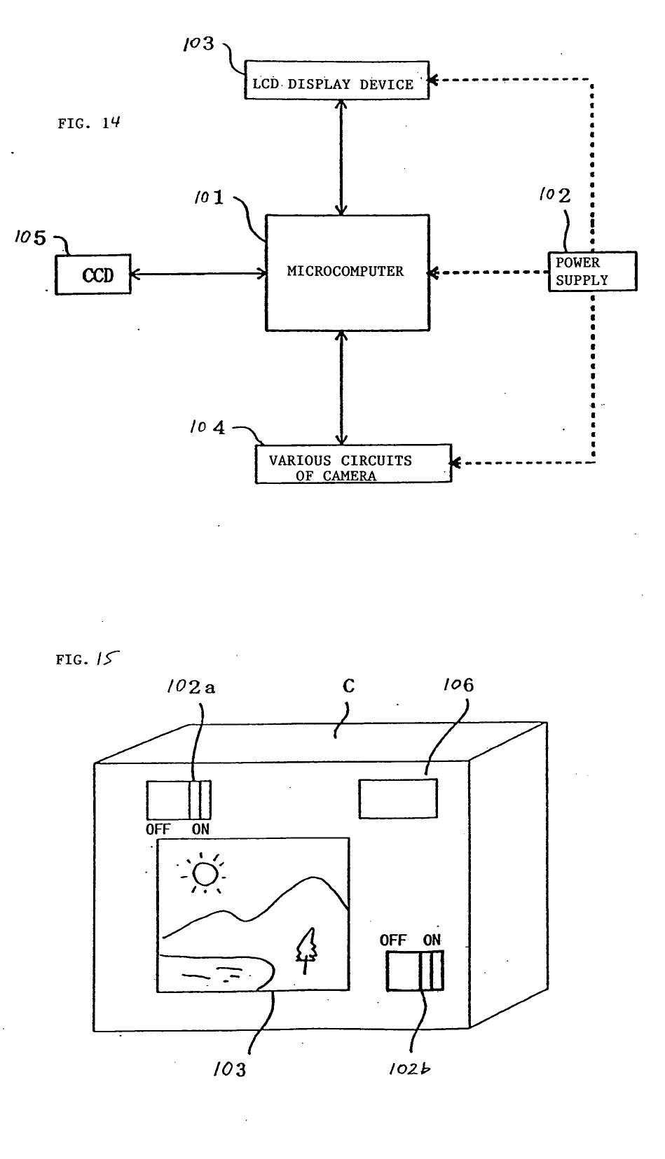

Another electronic camera according to the present invention will now be described referring to FIG. 14 through FIG. 19.

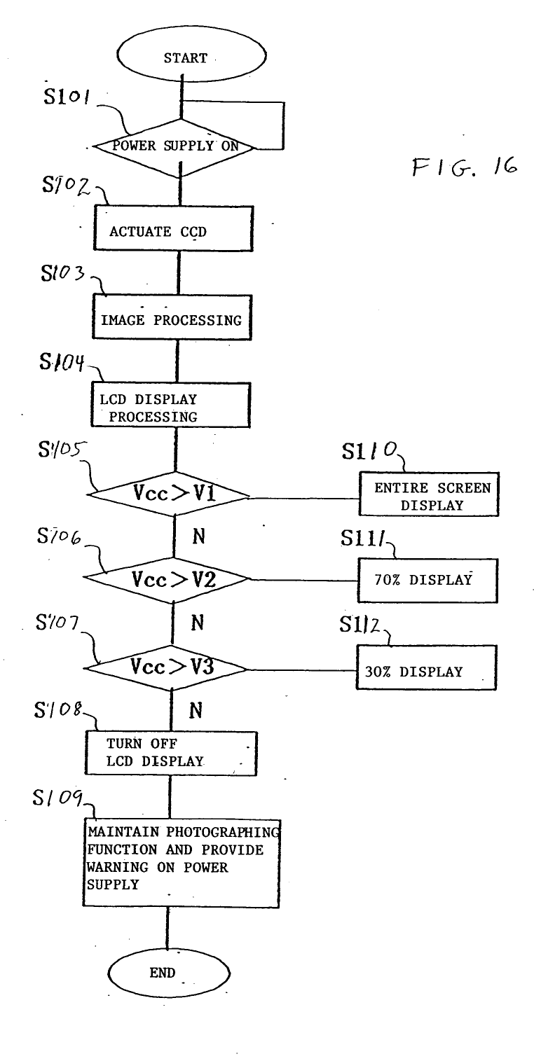

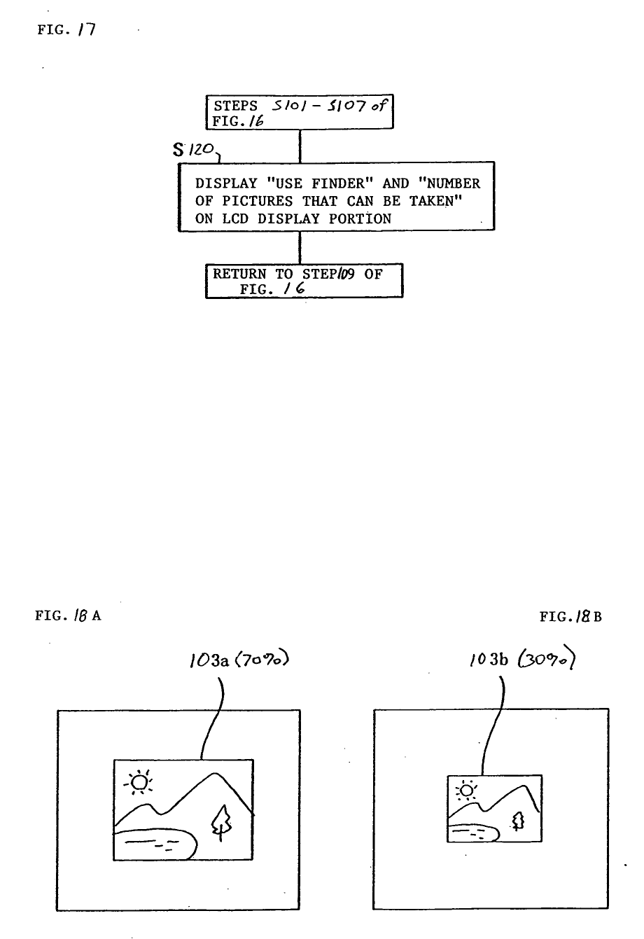

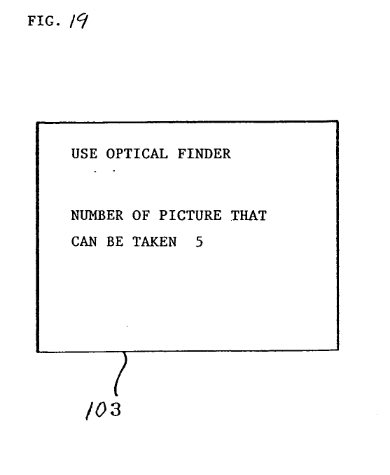

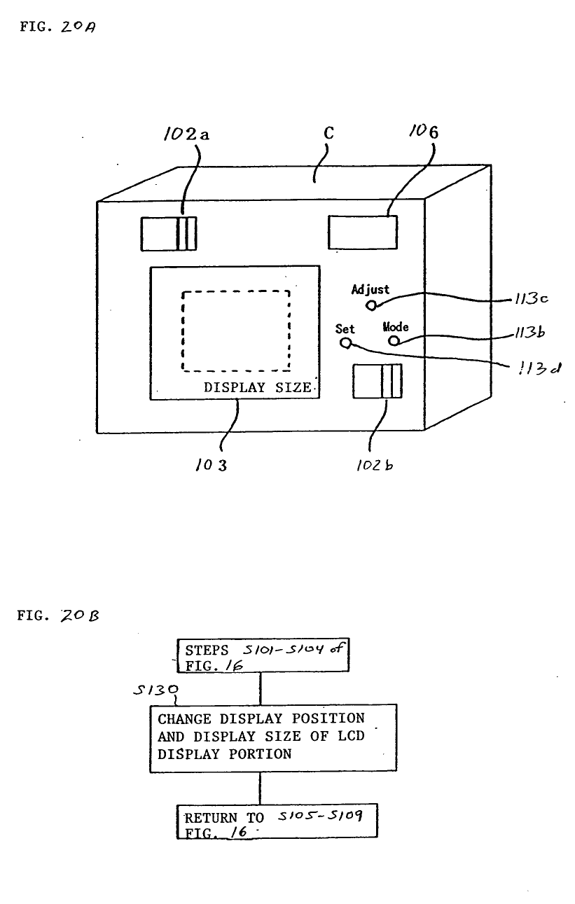

FIG. 14 is a block diagram of an electrical system of the electronic camera, and FIG. 15 is a rear view of the electronic camera. FIGS. 16 and 17 are flow charts of control programs executed by a microcomputer 101 of the electronic camera, and FIGS. 18A, 18B, and 19 show display examples of a large-screen liquid crystal display device 103 of the electronic camera.

The electronic camera of FIGS. 14-19 includes large-screen liquid crystal display device 103 provided in the rear face of the camera. Generally, the display device 103 dissipates or consumes a significant amount of electric power fed by a power supply (battery) of the camera. In this electronic camera (designated C in FIG. 15), the display area of the display device 103 is changed depending upon the remaining amount of power available to be fed by the power supply, to thus provide a plurality of display modes, so that a user of the camera is well informed of the current state of the power consumption.

In FIG. 14, power supply 102 feeds electric power to a microcomputer 101, display device 103, various circuits (for example, lens drive circuit, motor circuit, and photometric circuit) 104 of the camera, and an image pickup unit (such as CCD unit) 105 for capturing an optical image.

The display device 103 is mounted in the electronic camera C over substantially the entire area of the rear face thereof, and serves to project an image captured by the image pickup device 105. Photoelectric signals produced by the image pickup device 105 are processed by the microcomputer 101, and transmitted as image (video) signals to the display device 103. Thus, the image currently captured by the image pickup device 105 is displayed on the display device 103.

The display device 103 consists of a liquid crystal portion, and a back light portion (in the form of a fluorescent tube) for illuminating the liquid crystal portion. The liquid crystal portion and back light portion are each divided into sections corresponding to respective display modes, such that an appropriate section or sections of the liquid crystal portion and a corresponding section or sections of the back light portion are selected to establish each of the display modes.

More specifically, the liquid crystal portion and back light portion are divided into sections to provide respective shapes of display screen 103a of FIG. 18A and display screen 103b of FIG. 18B, for example, and these sections are respectively driven depending upon the selected display mode. Each section of the liquid crystal portion is provided with a known liquid crystal drive circuit, and each section of the back light portion is provided with a known back light drive circuit, such that the microcomputer 101 actuates the drive circuits for appropriate sections of the liquid crystal portion and back light portion, depending upon the selected display mode.

Where a desired image is displayed over the entire area of the display screen 103 (100% display), all of the liquid crystal drive circuits and back light drive circuits are actuated. Where the desired image is displayed in the display screen 103a (70% display), only the liquid crystal drive circuits and back light circuits that correspond to the display screens 103a and 103b are actuated. Where the desired image is displayed in the display screen 103b (30% display), only the liquid crystal drive circuit and back light circuit that correspond to the display screen 103b are actuated. In this arrangement, electric power is not fed to the circuits for the display screen that need not be actuated in the selected display mode, thereby preventing useless power consumption. The present embodiment may be modified such that the display screen 103 is divided into 9 sections or 16 sections, or some other desired number of sections, depending upon display modes to be established.

As shown in FIG. 15, the electronic camera C includes a power supply switch 102a, display switch 102b for selecting the display mode of the display device 103, and an optical finder or viewfinder 106.

The optical finder 106 may be used when a picture is taken while the display device 103 is not activated. Where only a small amount of electrical energy remains in the power supply 102, for example, the display switch 102b may be turned off to make the display device 103 inoperative while photographing.

Referring next to FIG. 16 and FIG. 17, the flow of processing of the microcomputer 101 will be now described.

Step S101: The power supply switch 102a is turned on, so that electric power is fed to respective circuits of the electronic camera C, to bring the camera in an operative state.

Step S102: A half-depressed button that is not illustrated is operated to be half-depressed, for example, so as to actuate the image pickup unit 105.

Step S103: The microprocessor 101 performs image processing based on photoelectric signals received from the image pickup unit 105, so as to generate image signals.

Step S104: The display device 103 receives the image signals to display a photographed image.

Step S105: The current voltage Vcc of the power supply 102 is compared with a reference voltage V1 required for the operation of the electronic camera. If the current voltage Vcc is higher than the reference voltage V1, the control flow goes to step S110, to display the image over the entire screen of the display device 103. If the electric power to be fed by the power supply 102 is reduced and the current voltage Vcc is lower than the reference voltage V1, the control flow goes to step S106.

Step S106: The current voltage Vcc of the power supply 102 is compared with a reference voltage V2 that is lower than the above-indicated reference voltage V1. If the result of the comparison indicates that the voltage Vcc of the power supply 102 is higher than the reference voltage V2, step S111 is executed to display the image in 70% of the screen (103a in FIG. 18A) of the display device 103. This is the case where the voltage Vcc is between the reference voltage V1 and the reference voltage V2.

If the voltage Vcc is lower than the reference voltage V2, the control flow goes to step S107.

Step S107: The current voltage Vcc of the power supply 102 is compared with a reference voltage V3 that is lower than the reference voltage V2. If the result of the comparison indicates that the voltage Vcc of the power supply 102 is higher than the reference voltage V3, step S112 is executed to display the image in 30% of the screen (103b in FIG. 18B) of the display device 103. This is the case where the voltage Vcc is between the reference voltage V2 and the reference voltage V3.

If the voltage Vcc is lower than the reference voltage V3, the control flow goes to step S108.

Step S108: The display device 103 turns off the display of the image.

Step S109: While the amount of electric power needed for normally operating the electronic camera still remains in the power supply 102, so as to maintain the photographing function of the electric camera, a warning display indicating a lack of energy in the power supply is provided. For the warning display, a symbol display for warning may be turned on, for example. The reference voltage V3 is set to such a level that the electronic camera is not made inoperative immediately after the current voltage Vcc falls below the reference voltage V3.

Since the reduced displays of FIG. 18A and FIG. 18B are obtained by reducing a full range, i.e., 100%, of the original image, the image that is being photographed can be entirely or completely displayed without missing any part thereof.

Referring next to FIG. 17, another method of displaying a warning will be described.

The control flow goes to step S120 after executing step S101 through step S107 of FIG. 16. In step S120 of FIG. 17, the electronic camera provides a warning display as shown in FIG. 19, to inform the camera user that the voltage Vcc of the power supply 102 has been reduced to such a low level that the electronic camera will soon be unable to operate in a normal manner.

More specifically, indications, such as “Use Optical Finder” and “Number of Pictures That Can Be Taken: xx”, may be displayed on the display device 103, as shown in FIG. 19.

With the above-described warning display provided, the user may be precisely informed of the number of pictures that can be taken, and the timing of replacing the power supply 102.

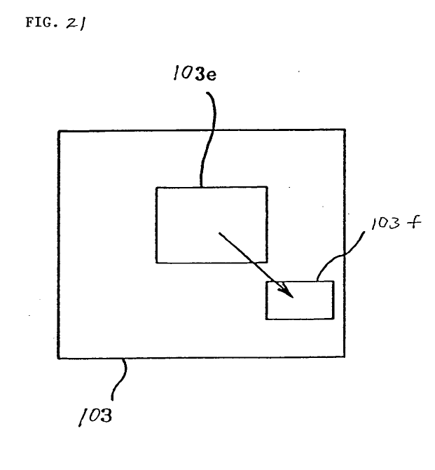

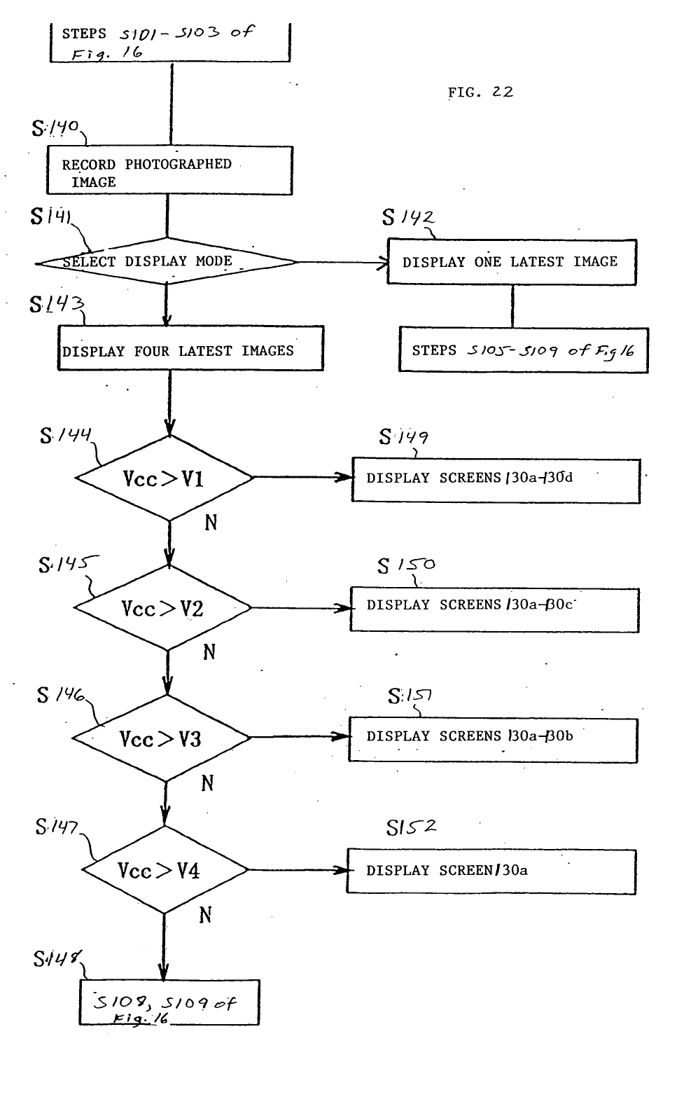

Referring to FIGS. 20A, 20B, and 21, another electronic camera of the invention will now be described. The present electronic camera adds a feature to the camera of FIGS. 14-19 in that it allows the user to change the display screen size and display position of the display device 103.

In FIG. 20A, the display size and display position of the display device 103 may be selected as desired by operating mode switch 113b, adjusting switch 113c and setting switch 113d.

The mode switch 113b is provided for selecting one of two modes, namely, a mode for setting the display size and a mode for setting the display position. If the display size mode is selected through the mode switch 113b, the adjusting switch 113c is operated to switch the display size from one of four predetermined sizes (100% screen, 80% screen, 60% screen, and 30% screen) to another. The setting switch 113d is then operated to establish the selected display size.

If the display position mode is selected through the mode switch 113b, any one of five positions, i.e., central position and four corner positions of the display screen, may be selected and established. For example, the display position may be changed from the central position 103e to the right, lower corner position 103f, as shown in FIG. 21. In this display position mode, one of the predetermined five display positions is selected by operating the adjusting switch 113c, and the selected display position is established by operating the setting switch 113d, as in the display size mode.

FIG. 20B shows a flow chart of the overall operation.

Basically, in FIG. 20B, a step S130 is added to the flow chart of FIG. 16. Step S130 corresponds to the display size and position select process just described.

In the above arrangement, the conditions of the display screen of the display device 103 may be set to those desired by the camera user, thus making it easier for the user to operate the electronic camera and view the display screen. Further, a small screen size may be selected when a large or full screen is not necessary, so as to achieve a saving of energy. It is also possible to check the available voltage of the power supply since the screen size is reduced as the power supply voltage is lowered, in the same manner as previously described.

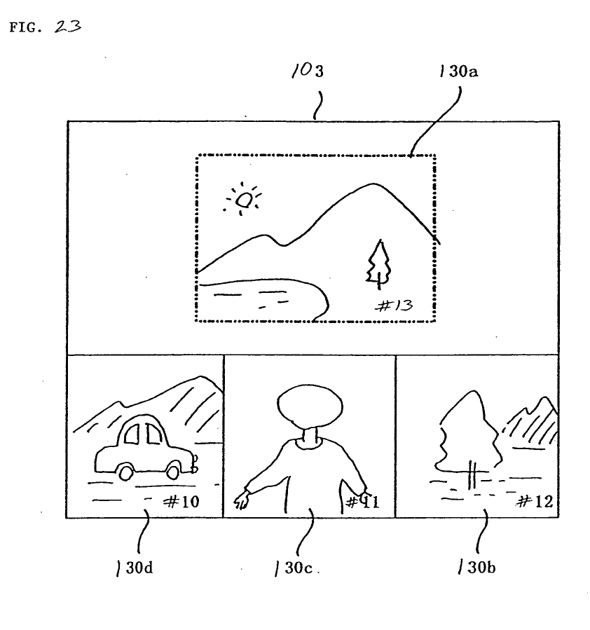

Another electronic camera according to the invention will now be described referring to FIG. 22 and FIG. 23. The present camera is provided by adding still another function to the electronic cameras described in connection with FIGS. 14-21, to allow the display device 103 to operate in additional display modes.

The present electronic camera is adapted to display both still images and a moving image on the display device 103. The still images represent images that were recorded in the past, and the moving image is of an object that is currently being imaged.

FIG. 22 is a flow chart of the operation. FIG. 23 is a view showing an example of a display on the display device 103.

The liquid crystal portion and back light portion of the display device 103 of FIG. 23 are divided into sections that correspond to display screens (display regions) 130a through 130d. Each section of the liquid crystal portion is provided with a liquid crystal drive circuit while each section of the back light portion is provided with a back light drive circuit, and appropriate sections of the liquid crystal portion and back light portion are actuated depending upon the selected display mode. Namely, the sections of the liquid crystal portion and back light portion that correspond to the display screen 130a are actuated to display a moving image in the display screen 130a, and the sections of the liquid crystal portion and back light portion that correspond to the display screens 130b, 130c, 130d are actuated to display still images in the respective display screens 130b, 130c, 130d.

The flow chart of FIG. 22 will now be described.

Following step S101 through step S103 in FIG. 16, the control flow goes to step S140.

Step S140: Images taken by the electronic camera are recorded in an image memory portion. The memory portion may be a flash memory or a magnetic disc, for example.

Step S141: The mode switch 113b shown in FIG. 20A is operated to select the display mode, and the adjusting switch 113c is then operated to select one of first display mode (step S142) and second display mode (step S143). The setting switch 113d is then operated to confirm the selected display mode.

Step S142: The display device 103 is driven in the first display mode. This first display mode is a normal display mode in which the current or latest moving image that is being photographed is displayed over the entire area of a display portion of the display device 103. Step S142 is followed by the same processing as performed in steps S105-S109 of FIG. 16.

Step S143: The display device 103 is driven in the second display mode, as shown in FIG. 23. In this second display mode, four images are displayed in respective display screens 130a, 130b, 130c, 130d. Specifically, the latest moving image that is being photographed is displayed in the display screen 130a, and images that were photographed in the past are successively displayed in the remaining three display screens 130b, 130c, 130d.

Step S144: If the voltage Vcc of the power supply 102 is higher than a reference voltage V1, step S149 is executed to maintain the second display mode in which the images are displayed in all of the display screens 130a-130d of the display device 103, while normally operating the electronic camera. If the voltage Vcc of the power supply 102 is lower than the reference voltage V1, on the other hand, the control flow goes to step S145.

Step S145: If the voltage Vcc of the power supply 102 is higher than a reference voltage V2, step S150 is executed to turn off the display screen 130d of the display device 103, and keep displaying the images in the other display screens 130a-130c, while normally operating the electronic camera. If the voltage Vcc of the power supply 102 is lower than the reference voltage V2, on the other hand, the control flow goes to step S146.

Step S146: If the voltage Vcc of the power supply 102 is higher than a reference voltage V3, step S151 is executed to turn off the display screens 130d, 130c of the display device 103, and keep displaying the images in the other display screens 130a, 130b, while normally operating the electronic camera. If the voltage Vcc of the power supply 102 is lower than the reference voltage V3, on the other hand, the control flow goes to step S147.

Step S147: If the voltage Vcc of the power supply 102 is higher than a reference voltage V4, step S152 is executed to turn off the display screens 130d, 130c, 130b of the display device 103, and keep displaying the image in the display screen 130a, while normally operating the electronic camera. If the voltage Vcc of the power supply 102 is lower than the reference voltage V4, the control flow goes to step S148.

Step S148: The control flow goes to steps S108, S109 of FIG. 16.

In the electronic camera just described, the image that is currently photographed is displayed, and the images that have been photographed are also displayed as still images. This makes it possible for the user to determine the angle and frame of an image that will be next photographed, in view of the images that have already been photographed. Thus, a variety of images can be recorded, for example, while preventing the user from taking a number of similar pictures.

Also the display of still images as just described provides the effect of a warning display indicating a lack of energy in the power supply.

While various preferred modes of the invention have been described above, it is to be understood that they are merely exemplary of the invention. Those of ordinary skill in the art will readily recognize that numerous variations are possible in keeping with the basic principles described herein, the scope of the invention being defined in the appended claims.

1. An electronic camera, comprising:
an imaging part which photoelectrically transduces an image of an object of imaging, and produces image signals;
an image memory part which stores the image signals from the imaging part; and
a display part which displays images based on the image signals,
wherein the display part has a moving picture display part and a still-image display part which respectively display a moving-picture image and a still-picture image.

2. The electronic camera of claim 1, wherein the moving-picture display part and the still-image display part provide the respective displays simultaneously.

3. The electronic camera of claim 1, wherein the display part includes a plurality of said still-image display parts.

4. The electronic camera of claim 3, including a device which detects a state of a power supply, and wherein a number of still-image display parts activated among said plurality is adjusted depending upon the detected state of the power supply.

5. The electronic camera of claim 3, wherein the plurality of still-image display parts display a corresponding plurality of consecutive still images.

6. The electronic camera of claim 1, wherein the still-image display part displays an image frame from a moving-picture image signal currently being stored to the image memory part.

7. The electronic camera of claim 1, wherein the still-image display part displays an image from an image signal previously stored to the image memory part.

8. The electronic camera of claim 1, wherein the moving-picture display part and the still-image display part are constructed by splitting a region within the same screen display.

9. The electronic camera of claim 3, wherein the moving-picture display part and the still-image display part are constructed by splitting a region within the same screen display.

10. An electronic camera, comprising:
an imaging part which images an object of imaging and generates moving-picture image information;
a recording part which records the image information generated by the imaging part on a recording medium; and
a display part which displays a thumbnail image corresponding to one frame of the image information when the generation or recording of the image information is initiated,
wherein the display part displays the thumbnail image with a depth dimension when recording of the image information is being continued by the recording part, and causes the depth dimension to increase in a monotonically non-decreasing manner as the duration of recording increases.

11. The electronic camera of claim 10, further comprising:
a calculating part which calculates a quantity of image information recorded as of successive predetermined times during a recording operation, and
wherein the display part causes the depth dimension of the thumbnail image to increase in a monotonically non-decreasing manner in accordance with the calculation results obtained by the calculating part.

12. The electronic camera of claim 10, wherein the display part displays an index corresponding to the amount of change in the depth dimension of the thumbnail image in a format which is predetermined in the direction of depth.

13. An electronic camera, comprising:
an image pickup device which photoelectrically converts an image of an object to produce an image signal;
a display device to display the image of the object, based on the image signal;
a power supply battery for feeding electric power to processing circuits of the image pickup device and the display part;
a detecting part for determining whether a level of a voltage provided by the power supply battery is lower than a predetermined value, and generating a detection signal when the detected level is lower than the predetermined value; and
a display control part which reduces a display region of the display device in response to said detection signal received from the detecting part.

14. An electronic camera, comprising:
an image pickup device which photoelectrically converts an image of an object to produce an image signal;
a display device to display the image of the object, based on the image signal;
a recording part for recording the image signal; and
a display controller which changes an area of a display region of the display device into a selected size, and moves the display region to a selected position.
